(19) United States
(12) Patent Application Publication
(10) Pub. No.: US 2012/0213625 A1
(43) Pub. Date: Aug. 23, 2012

(54) Robotic Palletizer Cell And Method Of Construction

(76) Inventor: Brian Thomas Roberts, Wixom, MI (US)

(21) Appl. No.: 13/400,213

(22) Filed: Feb. 20, 2012

Related U.S. Application Data
(60) Provisional application No. 61/444,507, filed on Feb. 18, 2011.

(51) Int. Cl. B65G 57/00; E04B 1/00

(52) U.S. Cl. 414/788.1; 52/741.1

(57) ABSTRACT

A method of constructing a palletizer cell by providing square platform bases which are assembled into an array in abutment with each other, each platform base mounting a respective component of palletizing equipment, such as a robot, one or more conveyors, a slip sheet bin, a discharge module, etc. with one platform base anchored to the factory floor and the rest attached to one or another of the platform bases to form the array of platform bases thereby properly locating the various equipment with each other by the fitting together of the platform bases. Safety fencing sections are mounted atop one or more outer sides to substantially enclose the space within the palletizer cell. Each platform base is formed with side openings which may be engaged with the tines of a fork lift.

### CROSS REFERENCE TO RELATED APPLICATIONS

This application claims the benefit of U.S. provisional application No. 61/444,507 filed on Feb. 18, 2011, incorporated herein by reference.

### BACKGROUND OF THE INVENTION

This invention concerns robotic palletizing cells, in which items are stacked by robots. Palletizing has in the past traditionally mostly been done by dedicated automation equipment.

In more recent years, robotic palletizing in which a robot carries out stacking of product has become more common for some applications, due to increased flexibility in layout, configuration, and pallet pattern creation and in running multiple lines.

Robotic palletizing involves custom designing the layout of the various pieces of equipment, such as the robot, conveyors, pallet stacks, etc., and then locating each piece of the equipment on the factory floor in the proper position and separately anchoring each piece of equipment to the factory floor, and running wires in the field to reach each electrically operated device.

Each piece of equipment also needs to be custom engineered and installed with the appropriate positional relationship to each other.

The result of this approach is that the time required to design, build and install a palletizer cell is considerable, and the cost relatively high.

While some attempts have been made to build standardized elements of the equipment needed, these have been lacking in their ability to be adapted to particular applications and to be configured differently for those applications, and in any event each element needed to be set up in the field in an appropriate position.

It is an object of the present invention to provide modular equipment and a method for creating pelletizing cells which make, designing, building and installing such cells much quicker and cheaper than previously possible by reducing the need for independently locating each item of equipment in the installation process.

### SUMMARY OF THE INVENTION

The above recited object as well as other objects which will be understood by those skilled in the art upon reading the following specification and claims are achieved by providing a plurality of standard modules which each incorporate a rectangular, preferably square, platform base of a uniform overall size and adapted to be held in contact with each other, as by attached connector plates, with at least one platform base anchored to the factory floor.

The platform bases are thereby formed into a fit together array of platform bases, thereby locating various palletizing equipment mounted to the platform bases relative to each other by simply assembling the platforms bases into an interfit array of modules on the factory floor.

Preferably, a robot module has its associated platform base anchored to the floor as by lag bolting projecting angled channel pieces located at spaced locations about its perimeter to the floor.

The remaining platform bases are fit together to form an array, with one or more platform bases held in contact with the perimeter of the robot module platform base and also to other of the platform bases which are held in contact with other platform bases. The array may be held together as by installing connector pieces overlapped with abutting portions of each platform base. Thus, the other platform bases may be left unanchored and only indirectly anchored to the floor by the connection to the anchored platform base; or, additional platform bases can also be anchored to the floor if desired. The platform bases of the robot module and the other modules and the equipment items mounted thereto are held in a predetermined spatial relationship by simply being together in the array.

The platform bases of each of the modules may comprise a thick steel plate supported above floor level as by having inwardly facing sections of channel or square tubing welded beneath the edges of the top plate on each side thereof.

Each platform base preferably has fork lift openings defined by gaps between the channel or square tube sections on each side. The projecting angled channel pieces of the anchored platform base may be received in the fork lift openings of the other the platform bases to be interfit therewith to allow side to side abutment of other platform bases therewith notwithstanding the presence of the projecting anchoring pieces.

The various types of modules which can be provided include a single or a double product feed conveyor, a slip sheet module, a pallet module, a discharge module with a chain conveyor for discharging loaded conveyors, each mounted to an associated platform base.

The platform bases may be in two different forms, a solid square forming a part of the above listed modules, and a platform base for a “build” module formed with a large opening extending into one side to create a U-shape while maintaining the overall square shape and size of the first form of platform base for allowing loading of a pallet disposed directly on the plant floor confined and located within the opening or for receiving a stack of pallets to be accessed by a robot.

Tapped hole patterns are provided machined into the upper surface of the top plate of each platform base for attaching connector pieces and also to allow mounting of uprights for supporting safety screens along one or more of the sides of each platform base to limit access to the interior space of the palletizer cell.

The modules can be arranged in many different configurations by assembling platform bases in various the positions within the array so as to minimize the engineering development necessary by the use of standardized components, allowing them to be provided at a lower cost.

### DESCRIPTION OF THE DRAWINGS

FIG. 1 is a pictorial view of a palletizer cell constructed according to the present invention.

FIG. 2 is a pictorial view of a second configuration of a palletizer cell constructed according to the present invention.

FIG. 3 is a pictorial view of a standard platform base, several of which being incorporated in the palletizer arrangements shown in FIGS. 1 and 2.

FIG. 3A is a plan view of a platform base having a slip sheet bin installed thereon showing the tapped hole patterns and a connector plate fixed thereto to connect to an adjacent platform base shown.

FIG. 3B is an enlarged broken away plan view of a blank platform base connected to a platform base having a slip sheet bin mounted thereon, showing the tapped hole patterns and additional connector plates and safety fence uprights and bases.

FIG. 4 is a pictorial view of a single pick module incorporated in the palletizer shown in FIG. 2.

FIG. 5 is a pictorial view of a build module also included in each of the palletizer cells shown in FIGS. 1 and 2.

FIG. 6 is a pictorial view of a slip sheet module incorporated in the palletizer cells shown in FIG. 2.

FIG. 7 is a pictorial view of a double pick module incorporated in the palletizer cell of FIG. 1.

FIG. 8 is a plan view of a platform base configuration adapted to be anchored to the floor and having a robot mounted thereon.

FIG. 9 is a pictorial view of a discharge module.

FIG. 10 is a pictorial view of a build module with a stack of pallets in position and with a safety light curtain activated in front of the pallet stack.

### DETAILED DESCRIPTION

In the following detailed description, certain specific terminology will be employed for the sake of clarity and a particular embodiment described in accordance with the requirements of 35 USC 112, but it is to be understood that the same is not intended to be limiting and should not be so construed inasmuch as the invention is capable of taking many forms and variations within the scope of the appended claims.

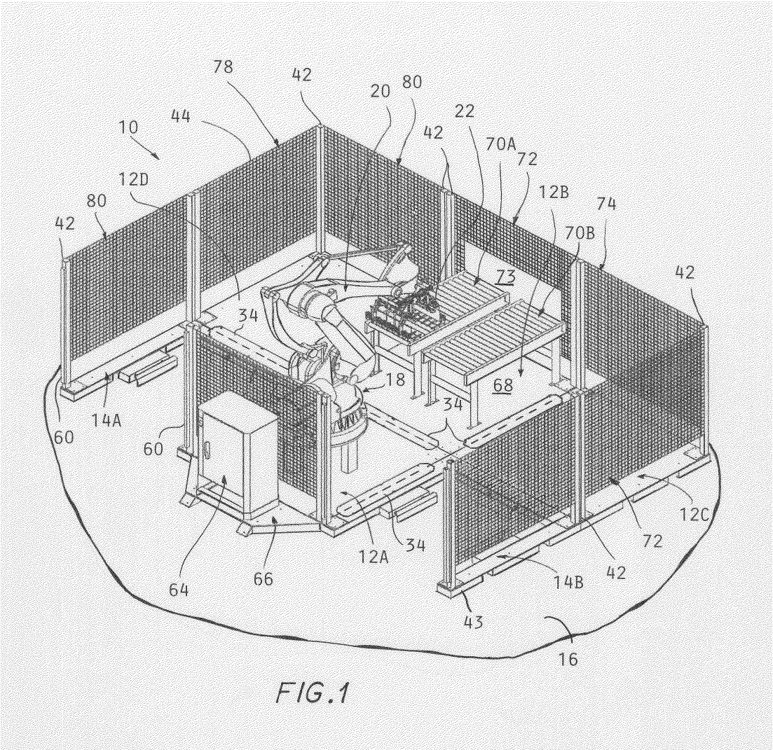

Referring to the drawings, and particularly FIG. 1, a palletizer cell 10 is shown, constructed using components according to the present invention. This includes a plurality of rectangular, preferably square, platform bases of two different types, i.e., four solid square platform bases 12A, 12B, 12C, and 12D, and two platform bases 14A, 14B of an overall square configuration but having an opening extending in from one side to create a general U-shape.

All of the platform bases 12A-12D and 14A, 14B rest on the factory floor 16, held together in contact with one another with one or more sides aligned and abutting with one or more sides of adjacent platform bases 12 or 14. This forms an array of fit together platform bases 12, 14 which have a fixed spatial relationship with each other, established by the contact of respective sides. The array of platform bases 12, 14 are held in their relative in contact positions, as by the use of connector plates 34 which overlap adjacent sides of abutting platform bases 12, 14 which are fixed thereto with screws threaded into holes extending into the top of adjacent platform bases 12, 14. Preferably, in order to minimize field operations only one platform base 12A may be anchored to the floor, platform base 12A, preferably the platform base associated with the robot module 18, which has mounted thereon a commercially available robot 20, equipped with a pickup gripper 22 for holding items to be palletized.

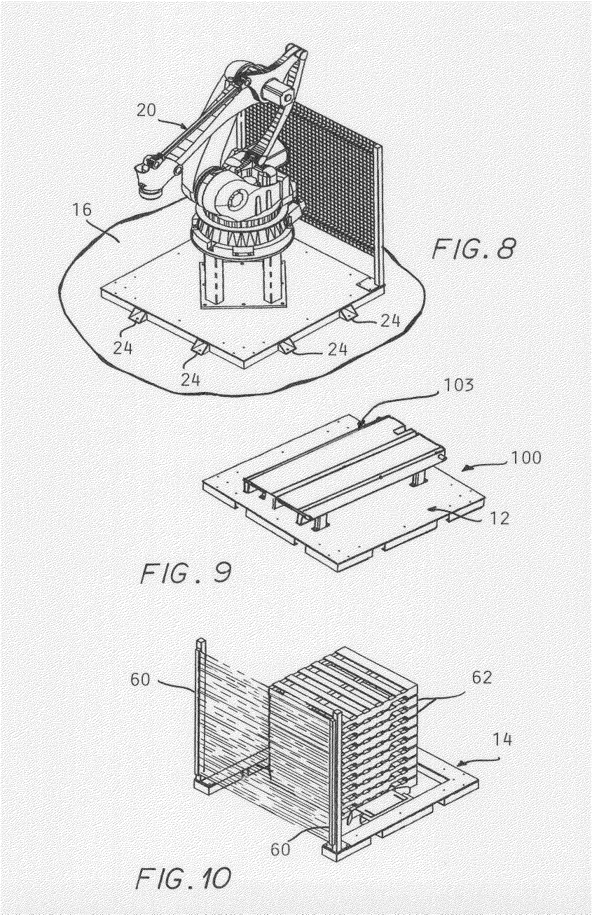

As seen in FIG. 8, the robot module platform base 12A has pairs of short angled channel sections 24 projecting from each side each of which have bottom holes allowing lag bolts to be inserted and received in anchors (not shown) installed in holes drilled in the floor 16, fixing the platform base 12A thereto.

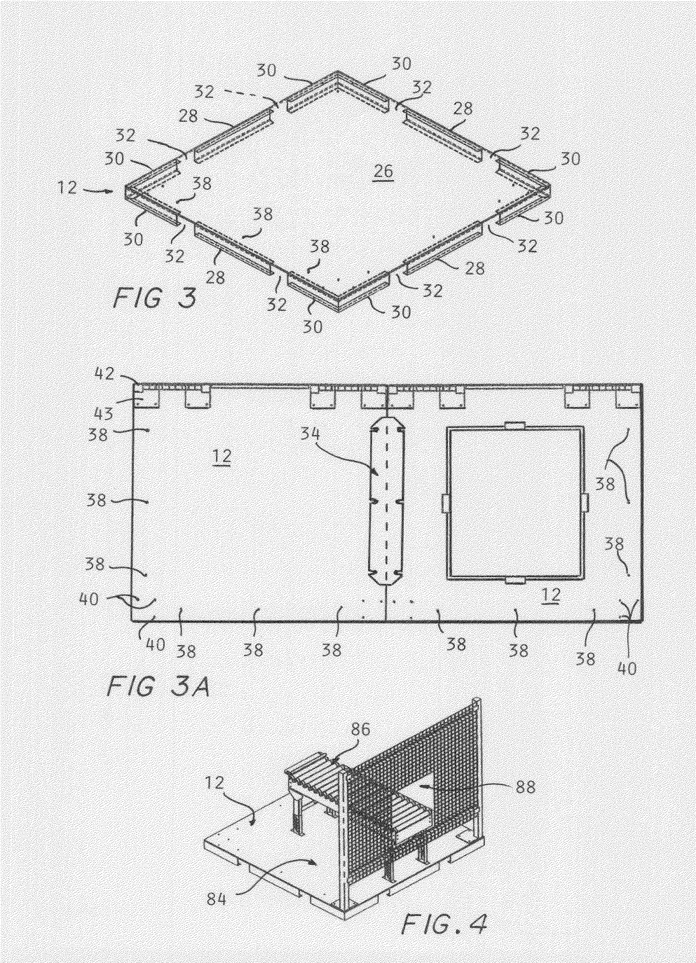

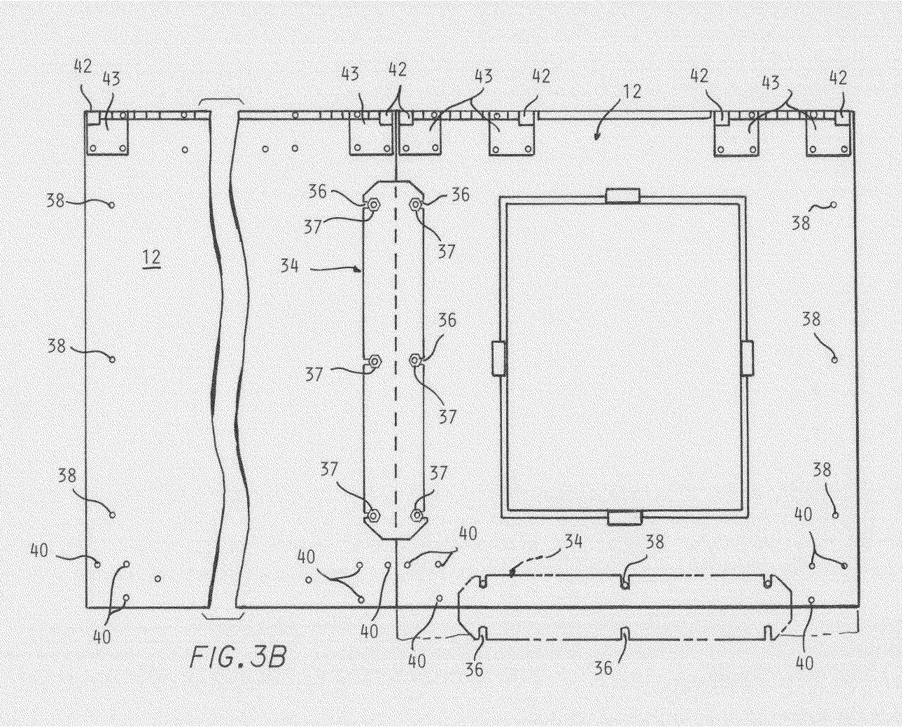

As seen in FIG. 3, all of the platform bases 12 are comprised of a top plate 26, preferably on the order of 78 inches square which size will effectively accommodate the range of motion of most commercially available robots. The platform bases 12, 14 are preferably made of structural steel, the top plate 26 of each approximately one half inch thick so as to be able to provide a rigid support for the loads and equipment to be placed thereon by the usual. A square shape of the platform bases 12 allows any side thereof to be abutted and aligned with any side of any other platform base 12, 14, maximizing the number of possible arrangements of such platform bases 12, 14 in an array.

The top plates 26 are supported spaced above the floor 16 by a series of channel sections 28, 30 located beneath the outer edge of each side of the top plate 16, welded in position with the open side facing inwardly. The longer channel sections 28 are each located at the middle of each side substantially flush with the outer edge thereof. Shorter sections 30 are mitered together and attached beneath each corner as seen in FIG. 3. A pair of spaces 32 are provided between the ends of the channel sections 28, 30 spaced apart and sized to enable the fork bars of a lift truck to be received therein for lifting and transporting the platform bases 12 or 14.

The short angled channel pieces 24 of the platform base 12A for the robot module 18 fit into these spaces 30 but are turned out so as to form an opening which still allows fork lift handling of the robot modules 18 during assembly of the cell 10.

As seen in FIGS. 3A and 3B, a tapped three hole pattern 38 is premachined centered along each side, matched to slots 36 in opposite sides elongated connector plates 34 which are used to held the platform bases 12, 14 together with respective sides aligned and in contact with each other to be indirectly located with respect to the robot module base plate 12A. The connector plates 34 each have a series of three slots 36 extending in from each side, spaced and sized to receive bolts 37 installed in the holes 38.

The top plates 26 also are premachined with three small tapped hole patterns 40 at each corner.

These are used to attach safety screen upright supports 42 which each have a flat mounting plate 43 fixed to the bottom end of the supports 42 as shown in FIG. 1. The safety screens 44 are installed along the outer side of the platform bases 12, 14 sized to extend across the entire length thereof, and blocking access to spaces within the palletizing cell 10.

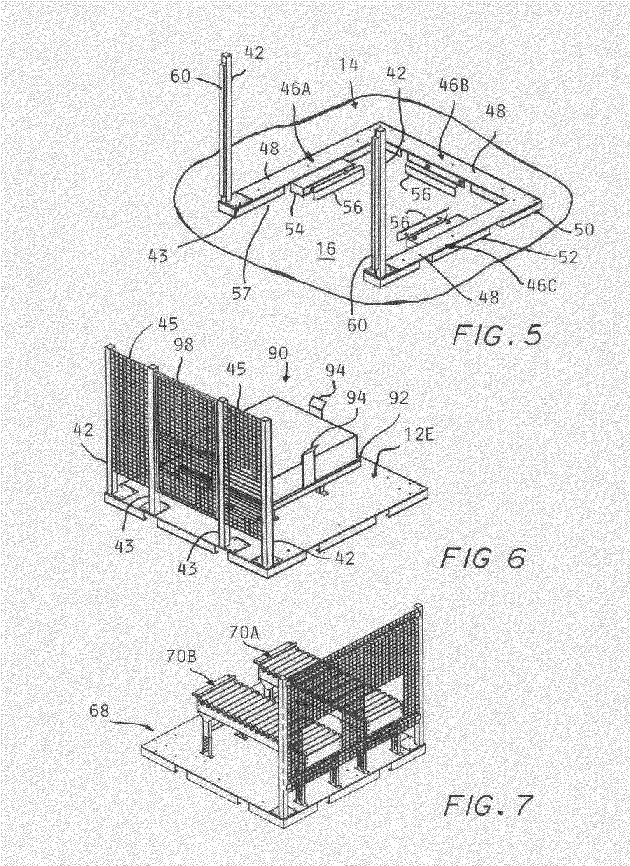

The platform bases 14A, 14B shown in FIG. 5 are of the same overall size as platform bases 12 (78 inches square) but have a large opening 57 extending in from one side to create a general U-shape, designed to receive a pallet to allow a product to be stacked on a pallet disposed directly on the floor surface 16.

Platform bases 14A, 14B are also constructed of a structural steel with a top plate 48 having inwardly facing four inch high rectangular tube sections 50, 52 welded to the underside of the three complete sides of the top plate 48. Spaces between the tube sections 50, 52 allow fork lift pickup as with the platform bases 12.

Pallet guide structures 54 are affixed to the inside of each of the three complete sides 46A, 46B, 46C having adjustable spacer plates 56 mounted thereto.

A tapped hole pattern may be premachined into the top plate 48 at the outer ends and the corners for mounting safety fence sections as well as a three hole pattern for the connecting plates along the middle of sides 46A, 46B, 46C.

Since the base platforms 14A, 14B must be unfenced at the outer end to allow fork truck access to a pallet or a pallet stack 62 shown in FIG. 10, light curtain sensor tubes 60 are required, which are well known commercially available devices which detect any intrusion into the interior of the palletizer cell (FIG. 10) through the opening, in the well known manner.

In the configuration of the palletizer cell shown in FIG. 1, two open sided platform bases 14A, 14B are included one on each side of the robot module 18 to accommodate a pallet on which a product stack is built.

A controls cabinet 64 may be located on an auxiliary platform 66, or optionally, directly on the factory floor 16.

A double pick module 68 is located opposite the robot module 18, comprised of a platform base 12B, having two side by side product conveyors 70A, 70B using a 24 volt motorized roller drive. Products are thereby alternately presented to the robot 20 from conveyors 70A, 70B loaded through an opening 73 in safety fence section 72 attached to the outer side of the platform base 12B. Product sensing photoeyes would be provided in the conventional manner to detect the presence of a product to be palletized.

Platform bases 12C and 12D with two fence sections 74, 76 and 78, 80 define protected access clearance spaces for keeping personnel out of those spaces through which the pick and place motions of the robot 20 occur. Thus, the in contact platform bases 12C, 12D define the proper spaces on either side of the conveyors 70A, 70B. The abutment and alignment of platform bases 12A and 12B locate the conveyors 70A, 70B with respect to the robot 20; and abutment of 14A, 14B with 12A properly locate the pallet receiving opening with respect to the robot 20 and conveyors 70A, 70B. Thus, the simple placement of the platform bases 12, 14 in contact with each other properly locates in the field the palletizer components of the cell 10 in relation to each other.

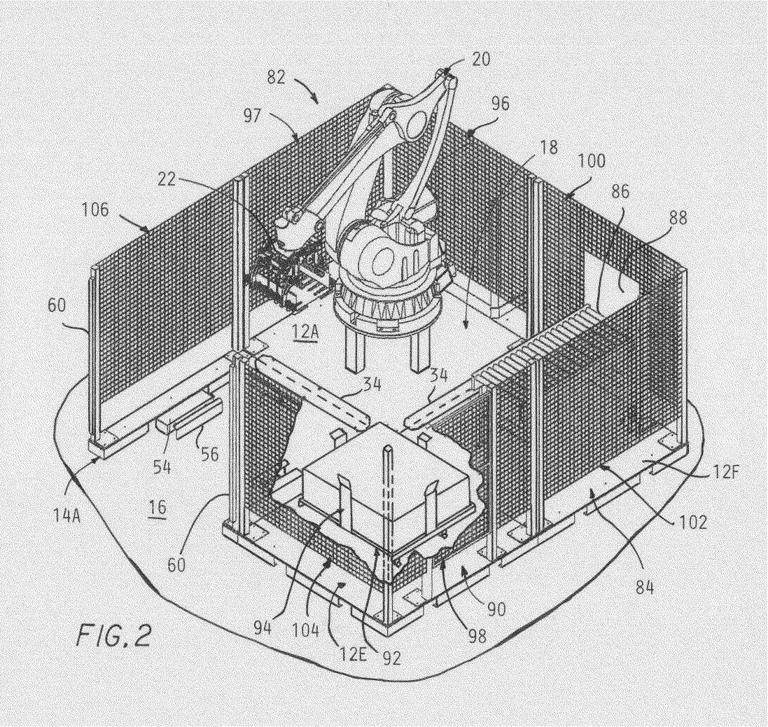

The robotic palletizer cell 82 shown in FIG. 2 includes the robot module 18 but it is placed at the rear of the cell 10, with a platform base 14A directly at the front. A single pick module 84 is located to one side, including a single pick powered conveyor 86 located aligned with an opening 88 in the safety fence 100.

A slip sheet module 90 is also included in the cell 82, located next to the single pick module 84. A slip sheet bin 92 rests atop a platform base 12E with adjustable guides 94 and a “low sheet” sensing photoeye (not shown) provided according to conventional practice.

Safety fence sections 96, 97 are mounted on sides of platform 12A, fence sections 100, 102 on two sides of platform base 12F, fence section 104 on one side of platform base 12E, and fence section 106 on one side of platform base 14A. An access gate 98 supported by uprights 43 between fence sections 4S supported by uprights 42,43 may be included on one side of the platform base 12E for loading slip sheets onto line 92.

An open sided platform base 14A is located next to the slip sheet module 90 configured with adjustable plates 56 as in the cell 10 shown in FIG. 1, with light curtain tubes 60 to protect against access through the unfenced opening.

The robot module 18 is bolted to the floor 16 with the other modules 84, 90, 14 anchored by being connected to the robot module, greatly simplifying installation of the cells 10, 82.

All of the components are thus fixed in the proper location disconnected with respect to each other by the fitting together and aligning of the various platform bases 12, 14 when assembled on the factory floor 16 held in mutually contacting position thereon.

It is possible that anchoring of additional platform bases 12 to the factory floor 16 may be carried out in order to hold the platform bases together in the array, however, this is not preferred as installation of the connector plates 34 is quicker and easier.

Other modules can be provided, including other equipment mounted to a standard platform bases 12, such as a discharge module 100 (FIG. 11) having a powered discharge conveyor 103 which allows powered transfer of loaded pallets.

Electrical lines to the photocells, electric motors, light curtains can be routed in conduits or covered channels extending along the sides of the platform bases 12, 14 (not shown).

The palletizer cells 10, 82 would normally first be assembled by the manufacturer in its shop, with the necessary wiring run to enable actual start up and trial before installation in the location where the cell is to be operated. The respective platform bases 12, 14 would then be disconnected for shipping to the final destination. The wiring would be disconnected left in the channels on the respective platform bases 12, 14.

Thus, when the platform bases 12, 14 are reassembled into the array, the proper locations of all of the components are automatically established by the interfitting of platform base. Likewise, the wiring needs only be reconnected, eliminating the need for running wiring in the field.

1. A robotic palletizer cell comprising a series of flat platform bases with a pick and place robot attached atop one of said platform bases, at least one of said platform bases being anchored to a supporting floor, each of said other platform bases fit together to said one platform base or to another platform base and fixedly held in that position, to thereby create an array of fit together platform bases, other equipment in said palletizer cell fixed to a respective one of said other platform bases and located in a fixed spatial relationship with each other by said array of fit together platform bases.

2. The palletizer according to claim 1 wherein each of said platform bases are of a generally rectangular uniform shape and having one of orthogonal sides thereof abutting a respective side of another platform base in said array.

3. The palletizer cell according to claim 1 further including safety fence sections attached to an outer side of each platform base by attachment of a pair fence uprights by end plates bolted to a respective platform base by a tapped hole pattern premachined into each end of said platform bases.

4. The palletizer cell according to claim 2 wherein each platform base is held on at least one side in abutment with a respective side to another platform base by a connector plate overlying abutting sides of said platform bases.

5. The palletizer cell according to claim 4 wherein each of said sides of each platform base has a tapped hole pattern preformed in a top surface adjacent each of said sides, holes in said pattern receiving bolts securing said connector plates thereto.

6. The palletizer cell according to claim 2 wherein each platform base comprises a planar top plate with a series of elongated pieces affixed to an undersurface of said top plate along each side thereof to support said top plate, elevated above said floor, with a pair of openings between said elongated pieces spaced and sized to receive fork lift tines therein.

7. The palletizer cell according to claim 6 wherein said one platform base has a pair of projecting lag bolt receiving pieces projecting from each side of said platform base adopted to receive anchoring elements driven into said supporting floor to secure said one platform base in a fixed position on said floor, said pieces located to be aligned with said forklift tine openings of said other platform bases and configured to be slidable therein.

8. The palletizer cell according to claim 2 wherein said platform bases are substantially square.

9. The palletizer cell according to claim 8 wherein said platform bases are approximately 78 inches square.

10. The palletizer cell according to claim 2 wherein at least one of said platform bases has an opening extending in from one side thereof to form a general U-shape to allow one or more pallets to be replaced therein resting on said supporting floor within said opening.

11. The palletizer cell according to claim 1 wherein said pieces of equipment mounted on a respective platform base includes one or more of a single pick conveyor, a double pick conveyor, a slip sheet bin, a pallet bin, or a discharge conveyor.

12. The palletizer cell according to claim 11 wherein at least one of said platform bases does not have any equipment mounted thereon to define an open clearance space for allowing room for robot motions within said cell.

13. The palletizer cell according to claim 6 wherein said top plate is formed of about one half inch thick structural steel.

14. A method of constructing a palletizer cell comprising providing a plurality of uniform substantially square platform bases; fixing at least one platform base to a supporting factory floor; fitting one or more of the other of said platform bases against at least one side of said one platform base and placing one or more sides of the remaining platform bases in contact with a side of another platform base and holding the same in said position thereby creating an array of platform bases held in position with at least one platform base anchored to said supporting factory floor; mounting a pick and place robot to one of said platform bases, and respectively mounting on one or more of said platform bases either a single pick conveyor, a double pick conveyor, or a slip sheet bin, or a discharge conveyor so as properly to locate said items with respect to each other within said cell by the contacting positions of said platform bases.

15. The method according to claim 14 further including forming an opening extending into one side of at least one of said platform bases to allow pallets to be placed on said supporting floor within said opening.

16. The method according to claim 14 further including attaching safety fences to the top edge of an outer side of said platform bases to substantially enclose said cell to prevent entry to an inside space of said palletizer cell.

17. The method according to claim 14 wherein said palletizer cell is first put together at another location remote from said one location for a trial operation with various components wired to a cell control, and then disassembled and shipped to said one location, further including disconnecting said wiring but leaving the same held on said platform bases and reconnecting said wiring after reassembling said platform bases at said one location.

18. The method according to claim 14 wherein said cell is first assembled at another location from said factory floor, and run from a cell control to each item of electrically powered equipment on a platform base, the cell then disassembled, with the wiring runs left in place on each platform base having electrically powered equipment thereon, but disconnected from said control, said wiring runs reconnected to said control when said cell is reassembled on said factory floor.
